(19) United States
(12) Patent Application Publication
(10) Pub. No.: US 2013/0262764 A1
(43) Pub. Date: Oct. 3, 2013

(54) MULTI-INTERFACE MEMORY CARD AND READ/WRITE DEVICE AND SYSTEM THEREOF

(71) Applicant: En-Min Jow, (US)

(72) Inventor: En-Min Jow, (US)

(73) Assignee: APTOS TECHNOLOGY INC., Hsinchu County (TW)

(21) Appl. No.: 13/430,709

(22) Filed: Mar. 27, 2012

(51) Int. Cl. G06F 12/00

(52) U.S. Cl. 711/115; 711/E12.001

(57) ABSTRACT

A multi-interface memory card includes a memory card shell, and a first memory card module and a second memory card module installed within the shell, in which the first memory card module and the second memory card module respectively have a first module interface and a second module interface, matching the same standard memory card specification and exposing to the shell surface; the read/write device of the multi-interface memory card has a slot and a mainframe interface for being plugged by the multi-interface memory card; the read/write device includes a first connector and a second connector exposing to the inside surface of the slot to connect with the first module interface and the second module interface of the multi-interface memory card, respectively, and the multi-interface memory card is transferred to the mainframe through the mainframe interface, to form a read/write system implementing data access to the multi-interface memory card.

### BACKGROUND OF THE INVENTION

(a) Field of the Invention

The present invention relates to a memory card, specifically to a multi-interface memory card and the read/write device and the read/write system thereof.

(b) Description of the Prior Art

The fresh memory card adopting fresh memory to store data is widely used in various types of electronic devices. As the rapid evolution of digital devices, various new types of memory card specifications are also launched, and the mainstream memory card (such as: SD, MMC, MS memory card) are launched with new miniaturized specification to match the miniaturized trend the device.

In addition to miniature packages, the memory card data transfer mode evolves at the same time, for example: SD series memory card and MMC series memory card have multi-bit signal transfer modes. Multi-bit parallel signal transfer will substantially improve the data transfer rates.

Currently, the application scope of the memory card is continuously expanded, and the industrial puts emphasis on data access optimization and data security improvement for the memory card, to improve the applicability. However, it is confined to general memory card standard specification, thus there is rare breakthrough in data access rate. Meanwhile, at this time of high degree convenience of Internet communications, all kinds of information security mechanisms are crack spread one after another, it is necessary to continue to put forward new information theft prevention program.

In view of this, the inventor provides the present invention to optimize data access and security through innovated modes.

### SUMMARY OF THE INVENTION

The main object of the present invention is to provide a multi-interface memory card and the read/write device and the read/write system thereof, through the package integration of multiple memory card modules in the same shell, multiple module interfaces are installed to expand bit channels, and the data of all bit channels are imported to every memory card module for storage, to significantly increase data access rate.

The secondary object of the present invention is to provide a multi-interface memory card and the read/write device and the read/write system thereof, through distributing data to different memory card modules of the multi-interface memory card for storage, it is difficult for general device reading and rebuilding data, to improve data security.

The still object of the present invention is to provide a multi-interface memory card and the read/write device and the read/write system thereof, through data encryption and decryption by the data encryption/decryption module of the read/write system, to improve the stored data confidentiality and data security.

The present invention discloses a multi-interface memory card, including a memory card shell, a first memory card module and a second memory card module. The first memory card module and the second memory card module are installed within the memory card shell, in which the first memory card module includes a first module interface, a first storage unit and a first control unit, and the second memory card module includes a second module interface, a second storage unit and a second control unit. The first module interface exposes to the memory card shell surface, and matches a standard memory card specification; the first storage unit is used for data storage; and the first control unit couples between the first module interface and the first storage unit, for controlling the data storage for the first storage unit. The second module interface exposes to the memory card shell surface, and matches the same standard memory card specification; the second storage unit is used for data storage; and the second control unit couples between the second module interface and the second storage unit, for controlling the data storage for the second storage unit.

The standard memory card specification is SD memory card, CF memory card, MMC memory card, SM memory card, MS memory card or xD memory card.

The present invention further discloses a read/write device, applying to the multi-interface memory card. The read/write device includes a device shell, a mainframe interface, a slot, a first connector, a second connector and a relay control module. The mainframe interface is installed at the device shell; the slot is integrated at the device shell for being plugged by the multi-interface memory card; the first connector has the structure applying to the first module interface of the multi-interface memory card, is installed within the device shell, and exposes to the inside surface of the slot, for connecting with the first module interface; the second connector has the structure applying to the second module interface of the multi-interface memory card, is installed within the device shell, and exposes to the inside surface of the slot, for connecting with the second module interface; and the relay control module couples among the first connector, the second connector and the mainframe interface, to transfer the first memory card module and the second memory card module of the multi-interface memory card to the mainframe interface.

The first connector and the second connector match the standard memory card specification to be the specification of SD memory card, CF memory card, MMC memory card, SM memory card, MS memory card and xD memory card.

The mainframe interface matches an interface specification of USB interface, IDE interface, ATAPI interface, SCSI interface, PCI interface, PCI Express interface, PCMCIA interface, IEEE1394 interface or ISA interface.

The present invention further discloses a read/write system, including a mainframe, the multi-interface memory card and read/write device. The read/write device includes a slot and a mainframe interface, in which the structure of the slot coordinates to be plugged by the multi-interface memory card, the mainframe interface is for coupling to the mainframe, and the read/write device couples between the mainframe and the multi-interface memory card, to transfer the first memory card module and the second memory card module of the multi-interface memory card to the mainframe.

The read/write device further includes a device shell, a first connector, a second connector and relay control module. The mainframe interface is installed at the device shell, and the slot integrates at the device shell, and coordinates to be plugged by the multi-interface memory card; the first connector has the structure applying to the first module interface, is installed within the device shell, and exposes to the inside surface of the slot, for connecting with the first module interface; the second connector has the structure applying to the second module interface, is installed within the device shell, and exposes to the inside surface of the slot, for connecting with the second module interface; and the relay control module couples among the first connector, the second connector and the mainframe interface, to transfer the first memory card module and the second memory card module to the mainframe interface.

For a specific embodiment, the mainframe further includes a data distribution processing module, for distributing the external data of the mainframe to import to the first memory card module and the second memory card module for storage.

For a specific embodiment, the read/write system further includes a data encryption/decryption module, for encrypting and importing the external data of the mainframe to the first memory card module and the second memory card module for storage, and for decrypting the internal data jointly stored by the first memory card module and the second memory card module, and then output by the mainframe.

The above description and the following detailed explanation and drawings are all for further describing the ways, means and effects adopted for achieving the predetermined object of the present invention. The other objects and advantages of the present invention will be described in the following explanation and drawings.

### BRIEF DESCRIPTION OF THE DRAWINGS

FIG. 1 is a schematic view showing system architecture of a specific embodiment of the multi-interface memory card of the present invention;

FIG. 2 is a schematic view showing appearance of a specific embodiment of the multi-interface memory card of the present invention;

FIG. 3 is a schematic view showing system architecture of a specific embodiment of the read/write system of the present invention;

FIG. 4 is a schematic view showing appearance of a specific embodiment of the read/write device of the present invention;

FIG. 5 is an exploded view of a specific embodiment of the read/write device of the present invention; and

FIG. 6 is a schematic view showing system architecture of another specific embodiment of the read/write system of the present invention.

### DESCRIPTION OF MAIN COMPONENT SYMBOLS

10: Multi-interface memory card
100: Memory card shell
101: Surface
11: First memory card module
111: First module interface
113: First control unit
115: First storage unit
12: Second memory card module
121: Second module interface
123: Second control unit
125: Second storage unit
20: Read/write device
200: Device shell
202: Slot
204: Circuit board assembly
206: Connection port component
21: Mainframe interface
23: Relay control module
25: First connector
27: Second connector
30, 50: Mainframe
31, 51: Data distribution processing module
40, 60: Read/write system
53: Data encryption/decryption module

### DETAILED DESCRIPTION OF THE PREFERRED EMBODIMENTS

The present invention provides a multi-interface memory card and the read/write device and the read/write system thereof, and the main feature is to package and integrate multiple memory card modules to a same storage device with multiple standard memory card interfaces, through the mechanism, more bit channels are for data access, the data access rate are substantially increased, and the data security is improved.

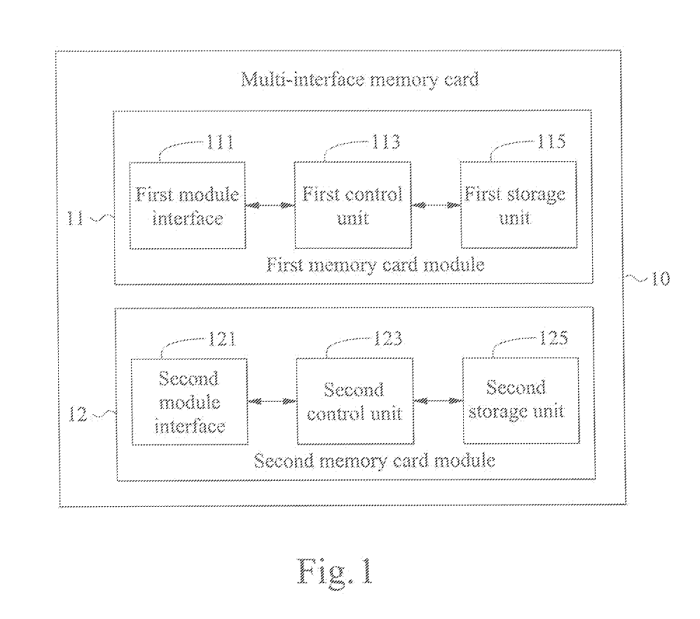

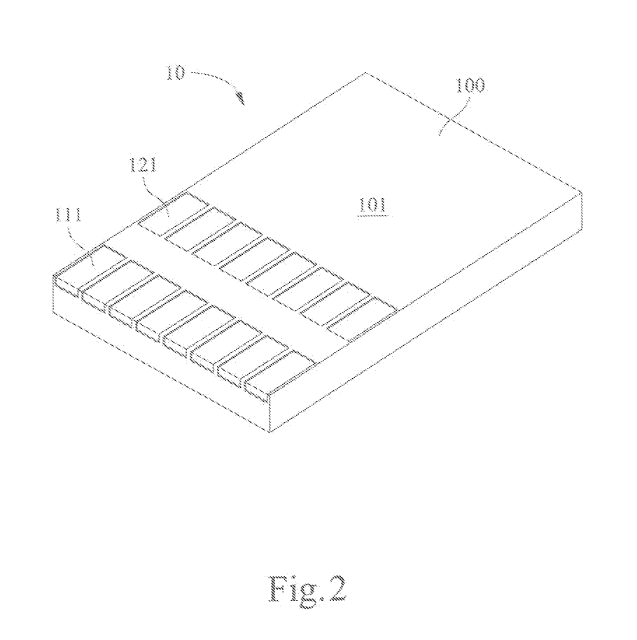

First, referring to FIG. 1 and FIG. 2, which are respectively the schematic views showing the system architecture and the appearance of a specific embodiment of the multi-interface memory card of the present invention. The explanation in advance is that, in the present invention, multiple standard memory card modules are packaged and integrated to a same storage device forming a multi-interface memory card, and the invention applies to more than two memory card modules, however, the following is exampled for two memory card modules, to describe various features, but which is not for limiting the scope of the present invention.

AS shown in the drawings, a multi-interface memory card 10 includes a memory card shell 100, whose overall structure matches a standard memory card specification or a specific customized specification. The multi-interface memory card 10 includes a first memory card module 11 and a second memory card module 12 installed within the memory card shell 100. The first memory card module 11 includes a first module interface 111, a first control unit 113 and a first storage unit 115, and the second memory card module 12 includes a second module interface 121, a second control unit 123 and a second storage unit 125.

The first module interface 111 and the second module interface 121 match the same standard memory card interface, with the gold finger pattern, and expose to a surface 101 of the shell 100. In this embodiment, the first module interface 111 and the second module interface 121 expose to the same surface 101, however, in other embodiments, the module interface is flexibly arranged at different surface in accordance with substantive requirements.

The first storage unit 115 and the second storage unit 125 are constituted by non-volatile memory (such as fresh memory) and used for data storage. The first control unit 113 couples between the first module interface 111 and the first storage unit 115, links with the external data through the first module interface 111, and accepts the external command to control the data access to the first storage unit 115. The second control unit 123 couples between the second module interface 121 and the second storage unit 125, links with the external data through the second module interface 121, and accepts the external command to control the data access to the second storage unit 125. The operational modes of the first memory card module 11 and that of the second memory card module 12 match the same standard memory card specification. In addition, the standard memory card specification is the specification of SD memory card, CF memory card, MMC memory card, SM memory card, MS memory card and xD memory card.

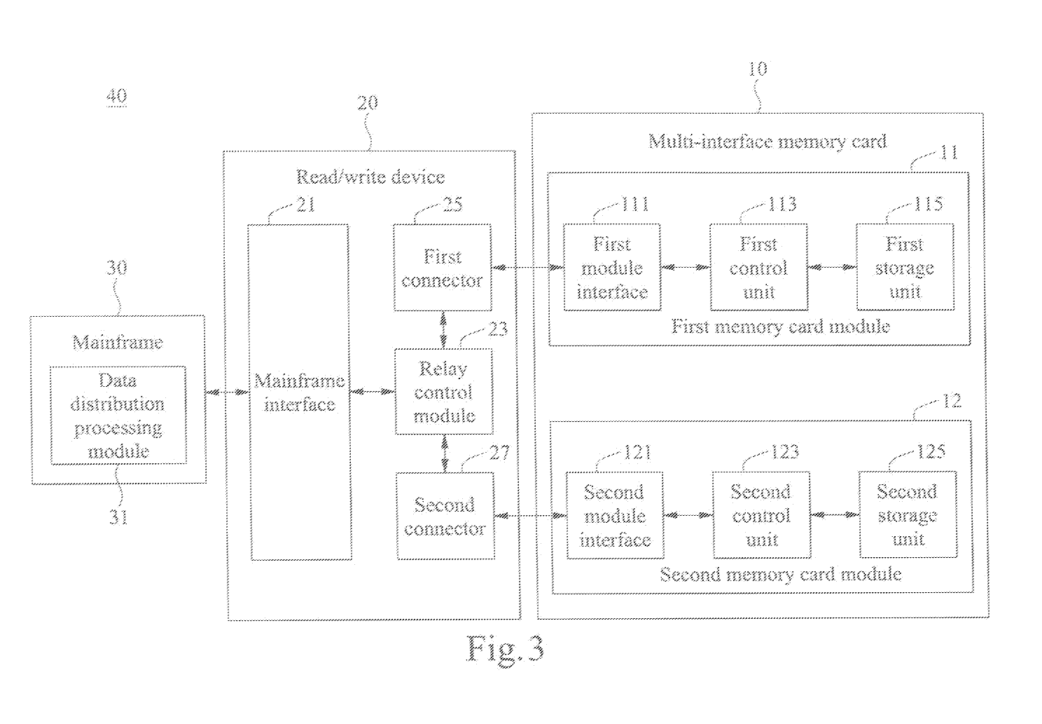

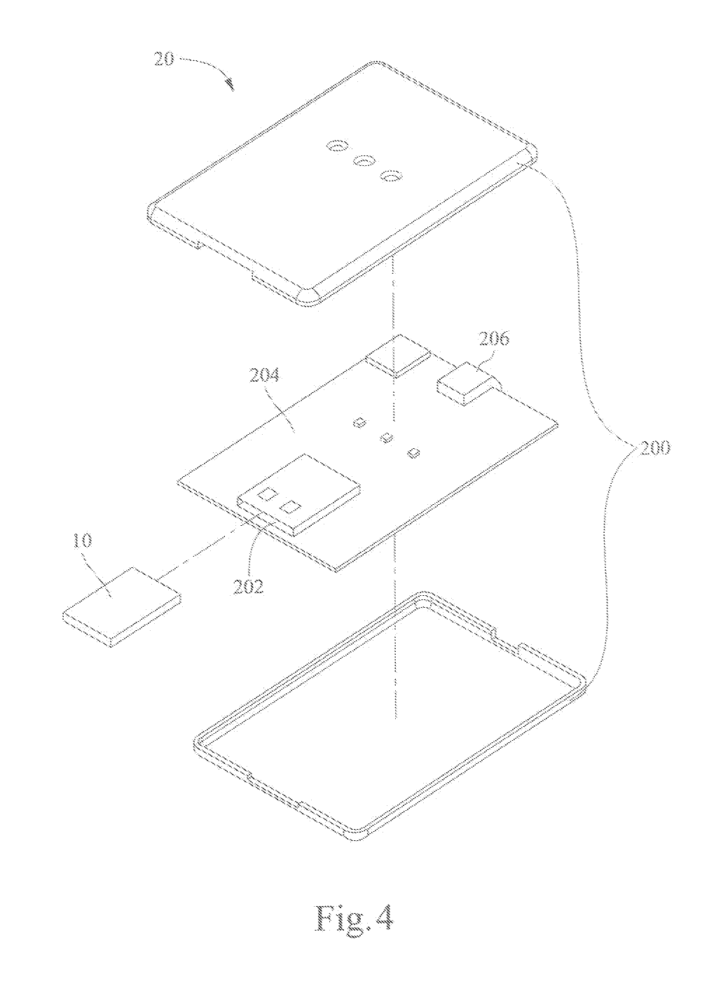

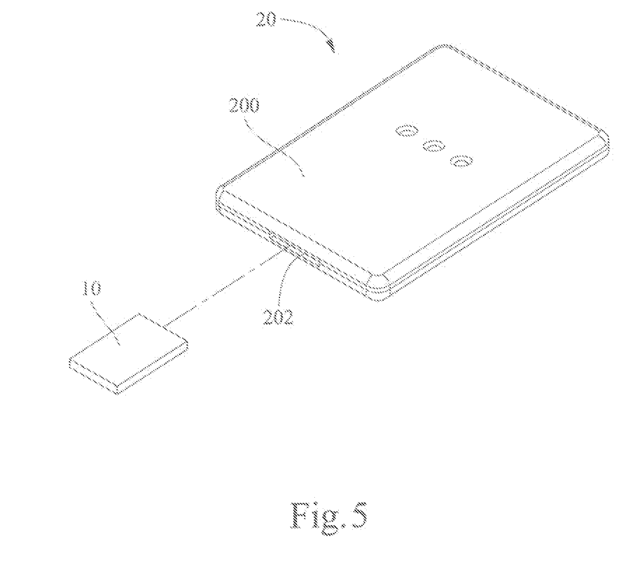

Next, referring to FIG. 3, FIG. 4 and FIG. 5, to continuously describe the read/write device and the read/write system of the multi-interface memory card 10, which are respectively a schematic view showing system architecture of a specific embodiment of the read/write system, a schematic view showing appearance and an exploded view of a specific embodiment of the read/write device of the present invention. As shown in the drawings, a read/write system 40 is jointly constituted by the multi-interface memory card 10, a read/write device 20 and a mainframe 30, in which the mainframe 30 is a computer system, and the read/write device 20 is the so-called reader.

The read/write device 20 applies to matching using with the multi-interface memory card 10, whose mechanism mainly has a device shell 200, a circuit board assembly 204, a slot 202 and a connection port component 206, in which the slot 202 and the connection port component 206 are installed at the circuit board assembly 204, and integrated at the device shell 200, and the structure of the slot 202 coordinates to be plugged by the multi-interface memory card 10.

The operation system of the read/write device 20 includes a mainframe interface 21, a first connector 25, a second connector 27 and a relay control module 23. The mainframe interface 21 is installed at the device shell 200, and integrated at the connection port component 206, for directly or indirectly coupling to the mainframe 30. The structures and arrangements of the first connector 25 and the second connector 27 respectively coordinate to the first module interface 111 and the second module interface 121 of the multi-interface memory card 10, to make flexible pin type, and to expose to the inside surface of the slot 202, for connecting with the first module interface 111 and the second module interface 121, to be electrically coupled to the multi-interface memory card 10.

The relay control module 23 couples among the first connector 25, the second connector 27 and the mainframe interface 21, for two-way transformation for the signal transfer mode of the mainframe 30 and the multi-interface memory card 10, to transfer the first memory card module 11 and the second memory card module 12 to the mainframe 30. The relay control module 23 is used for the circuit board assembly 204 integrated and installed at the device shell 200. In addition, the mainframe interface 21 matches the specification of USB interface, IDE interface, ATAPI interface, SCSI interface, PCI interface, PCI Express interface, PCMCIA interface, IEEE 1394 interface or ISA interface.

The mainframe 30 establishes data links through the read/write device 20, the first memory card module 11 and the second memory card module 12, and there is a data distribution processing module 31 installed to distribute and import external data to the first memory card module 11 and the second memory card module 12 for jointly storage, according to built-in logic; and the mainframe 30 reversely reads, rebuilds and outputs the jointly stored internal data of the first memory card module 115 and the second memory card module 125.

The multiple standard memory card interfaces of the multi-interface memory card 10 (i.e. the first module interface 111 and the second module interface 121 of this embodiment) will provide multiple bit channels. The read/write system 40 simultaneously uses all bit channels for data access to multiple memory card modules (i.e. the first memory card module 11 and the second memory card module 12 of this embodiment), which will substantially increase the data transmission rate. On the other hand, the data is stored in the first memory card module 11 and the second memory card module 12 through staggered distribution by the data distribution processing module 31, and general readers and computers cannot access, rebuild and output the data in the multi-interface memory card 10, to provide information security.

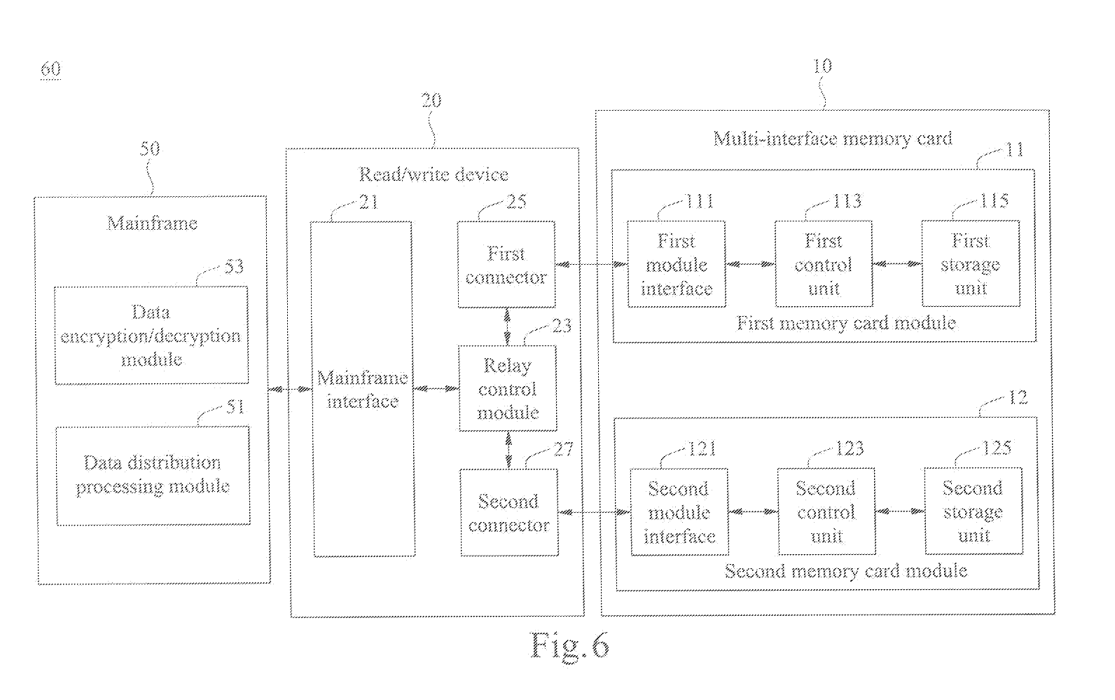

The data encryption mechanism is additionally installed at the read/write system of the multi-interface memory card 10, to improve data security. Referring to FIG. 6, which is a schematic view showing the system architecture of another embodiment of the read/write system of the present invention. In a read/write system 60 of this embodiment, a mainframe 50 includes a data distribution processing module 51 and a data encryption/decryption module 53. The data encryption/decryption module 53 performs encryption processing on the external data through built-in algorithm, and the data distribution processing module 51 imports the encrypted data to the multi-interface memory card 10 for storage, through the read/write device 20. The internal data stored by the multi-interface memory card 10 is read and rebuilt by the multi-interface memory card 10, and then decrypted and restored by the data encryption/decryption module 53, to further improve data security.

By the way, in this embodiment, the data encryption/decryption module 53 is additionally installed at the mainframe 50 to achieve data security, however, in the other embodiments, the data encryption/decryption module is flexibly integrated within the read/write device 20, or integrated within individual memory card module of the multi-interface memory card 10.

From the above, there are multiple memory card modules integrated within the multi-interface memory card of the present invention, through multiple bit channels formed by multiple module interfaces, data simultaneously distributed and imported to every memory card module for storage, thus the data access rate is substantially increased. In addition, for the present invention, the data is stored in various memory card modules through staggered distribution, and general readers and computers cannot access and rebuild the data in different memory card modules, to provide information security. Moreover, through the data encryption mechanism additionally installed at the read/write system, the stored data is encrypted, to further enhance data privacy and data security.

The above-mentioned are detailed explanations and drawings of specific embodiments of the present invention, which are not used for limiting the present invention, the scope of the present invention falls within the following claims, and the changes and modifications easily understood by every skilled in the art are covered within the scope of the present invention.

1. A multi-interface memory card, including:
a memory card shell;
a first memory card module, installed within the memory card shell, including:
a first module interface, exposing to the memory card shell surface, in which the first module interface matches a standard memory card specification;
a first storage unit, for data storage; and
a first control unit, coupling between the first module interface and the first storage unit, for controlling the data storage for the first storage unit; and
a second memory card module, installed within the memory card shell, including:
a second module interface, exposing to the memory card shell surface, in which the second module interface matches the standard memory card specification;
a second storage unit, for data storage; and
a second control unit, coupling between the second module interface and the second storage unit, for controlling the data storage for the second t storage unit.

2. The multi-interface memory card as claimed in claim 1, in which the standard memory card specification is selected from a memory card specification of a group composed of SD memory card, CF memory card, MMC memory card, SM memory card, MS memory card and xD memory card.

3. The multi-interface memory card as claimed in claim 1, in which the first module interface and the second module interface expose to the same surface of the memory card shell.

4. A read/write device, applying to the multi-interface memory card as claimed in claim 1, in which the read/write device includes:
a device shell;
a mainframe interface, installed at the device shell;
a slot, integrated at the device shell for being plugged by the multi-interface memory card;
a first connector, with the structure applying to the first module interface of the multi-interface memory card, which is installed within the device shell, and exposes to the inside surface of the slot, for connecting with the first module interface;
a second connector, with the structure applying to the second module interface of the multi-interface memory card, which is installed within the device shell, and exposes to the inside surface of the slot, for connecting with the second module interface; and
a relay control module, coupling among the first connector, the second connector and the mainframe interface, to transfer the first memory card module and the second memory card module of the multi-interface memory card to the mainframe interface.

5. The read/write device as claimed in claim 4, in which the first connector and the second connector match the standard memory card specification, and the standard memory card specification is selected from a memory card specification of a group composed of SD memory card, CF memory card, MMC memory card, SM memory card, MS memory card and xD memory card.

6. The read/write device as claimed in claim 4, in which the mainframe interface matches an interface specification selected from a group composed of USB interface, IDE interface, ATAPI interface, SCSI interface, PCI interface, PCI Express interface, PCMCIA interface, IEEE1394 interface and ISA interface.

7. A read/write device, including:
a mainframe;
the multi-interface memory card as claimed in claim 1; and
a read/write device, including a slot and a mainframe interface, in which the structure of the slot coordinates to be plugged by the multi-interface memory card, the mainframe interface is for coupling to the mainframe, and the read/write device couples between the mainframe and the multi-interface memory card, to transfer the first memory card module and the second memory card module of the multi-interface memory card to the mainframe.

8. The read/write system as claimed in claim 7, in which the read/write device further includes:
a device shell, wherein the mainframe interface is installed at the device shell, and the slot integrates at the device shell, and coordinates to be plugged by the multi-interface memory card;
a first connector, with the structure applying to the first module interface of the multi-interface memory card, which is installed within the device shell, and exposes to the inside surface of the slot, for connecting with the first module interface;
a second connector, with the structure applying to the second module interface of the multi-interface memory card, which is installed within the device shell, and exposes to the inside surface of the slot, for connecting with the second module interface; and
a relay control module, coupling among the first connector, the second connector and the mainframe interface, to transfer the first memory card module and the second memory card module to the mainframe interface.

9. The read/write system as claimed in claim 8, in which the mainframe includes a data distribution processing module, for distributing the external data of the mainframe to import to the first memory card module and the second memory card module for storage.

10. The read/write system as claimed in claim 8, further including a data encryption/decryption module, for encrypting and importing the external data output by the mainframe to the first memory card module and the second memory card module for storage, and for decrypting the internal data jointly stored by the first memory card module and the second memory card module, and then output by the mainframe.
